(19) United States
(12) Patent Application Publication
(10) Pub. No.: US 2026/0222808 A1
(43) Pub. Date: Jul. 30, 2026

(54) METHOD TO AUTHENTICATE AN ELECTRONIC DEVICE

(71) Applicant: Nomono AS, Trondheim (NO)

(72) Inventor: Karoline MÜLLER, Trondheim (NO)

(21) Appl. No.: 19/144,832

(22) PCT Filed: Dec. 28, 2023
(86) PCT No.: PCT/EP2023/087934

§ 371 Date: Jun. 30, 2025

(30) Foreign Application Priority Data
Dec. 30, 2022 (DK) PA 2022 70659

(51) Int. Cl. H04W 12/06; H04W 4/80; H04W 84/12

(52) U.S. Cl. CPC H04W 12/06; H04W 4/80; H04W 84/12

(57) ABSTRACT

The invention concerns a method for authenticate an electronic device with a subscription service executed on a network node by use of a UE, said subscription service configured to receive and process data files, in particularly recorded sound data, from said electronic device; wherein the UE stores subscription information for authentication to the subscription service, said subscription associated with a user or a user group.

The present application claims priority of DK application PA 2022 70659 dated Dec. 30, 2022, the disclosure of which is incorporated herein in its entirety by reference.

The present invention concerns a method for authenticating an electronic device with a subscription service executed on a network node by use of a UE, said subscription service configured to receive and process data files, in particularly recorded sound data, from said electronic device; wherein the UE stores subscription information for authentication to the subscription service, said subscription associated with a user or a user group. The present invention also concerns a UE and an electronic device.

### BACKGROUND

Recent developments enable linking between mobile phones, wherein referred to as UE and other electronic devices via a wireless link. Examples for such connection include for example smart watches. Those watches provide additional functionality like the monitoring and surveillance of body function and the like.

Pairing of such devices is usually done with the owner's mobile, enabling the electronic device only to communicate with the paired mobile but not with anything else. This also requires the mobile to be present and active. In some instances, the presence of a mobile is however not desirable, or the mobile is temporarily switched off. In other applications, functionality of such electronic devices may be limited or restricted oi the phone is not present.

In some applications, a user has subscribed to a service, for example to a sound processing service, whereas the user has the possibility to upload sound files for processing those files. Such application is interesting for podcaster, professional sound engineers and the like. While the subscription service can process any kind of uploaded sound files by a user via a mobile or a computer, it may be convenient to provide higher flexibility by enabling a recording device to directly communicate with the subscription service.

Conventional techniques therefore are sometimes cumbersome, inflexible or require a higher administrative effort. Consequently, there is a desire to simplify the authentication process while maintaining a high flexibility.

### SUMMARY OF THE INVENTION

This and other objects are addressed by the subject matter of the independent claims. Features and further aspects of the proposed principles are outlined in the dependent claims.

The inventors suggest a simpler solution for authenticating an electronic device with a subscription service executed on a network node by use of a UE. To ensure a higher flexibility, the electronic device shall be enabled by the authentication process to communicate over known networks and access point directly with the subscription service without the need for renewed authentication. In addition, the proposed methods by-pass the UE completely, once the authentication process is finished, enabling a user to use the electronic device without the need or presence of the UE.

Re-authentication with a different subscription is possible, whereas the electronic device is authenticated with the new subscription after releasing the previous Particularly pairing, for broadcast applications, whereas several content producers are sharing one or more electronic devices, such approach simplifies the use and creation of content significantly.

In some aspects a method for authenticating an electronic device with a subscription service executed on a network node by use of a UE is proposed. Said subscription service is configured to receive and process data files, in particularly recorded sound data, from said electronic device. The UE stores subscription information for authentication to the subscription service and said subscription is associated with a user or a user group. For the purpose of this application, a UE is any device used directly by an end-user to communicate. It can be a hand-held telephone, a mobile, a laptop computer equipped with a mobile broadband adapter, a tablet, or any other device configured to wireless communicate with a base station or an access point. The UE may connect to the base station Node B/eNodeB or to a wireless access point using WLAN, 3GPP, UMTS, 4G, LTE, 5G or any other high speed data connection suite. For simplicity a UE in the present non-limiting examples include a mobile or a tablet and the like.

The method according to the proposed principle comprise the step of establishing by the UE a first communication link to a network access point via a first wireless communication protocol (WLAN), said network access point connected to the network node by a communication network. Usually, authentication or login to the subscription service on the network node is possible by the user through said first wireless communication protocol and said communication protocol.

In some instances, the UE determines whether the connection to the network access point and subsequently to the subscription service can be established prior to initiating the next steps. If successful, the next steps are performed and executed. This will prevent to UE from executing certain steps of the proposed method which turn out to be not successful or in vain, for example, because the WLAN connection cannot be established, or the subscription service is down.

Further, a second communication link to the electronic device is establishing by the UE via a second wireless communication protocol having a smaller bandwidth and a shorter range than the first wireless communication protocol.

Once the second communication link to the electronic device is established, the UE provides to the electronic device network access information for the first wireless communication protocol for the purpose of establishing a communication link to the network access point referred to as third communication link.

In addition, the UE also provides to electronic device via the second communication link the subscription information. Likewise, the electronic device now establishes the third communication link to the network access point using the first wireless communication protocol. This step can also be performed prior to providing the subscription information by the UE. In some instances, the electronic device provides a feedback to the UE in response to successful establishing the third communication link. In response thereto the UE may provide the subscription information.

Once, the subscription information is received by the electronic device, the electronic device registers itself with the subscription service using the subscription information. For this purpose, it utilizes the established third communication link. Any further communication between the electronic device and the subscription service is done directly via the third communication link. The UE may no longer be required.

Furthermore, the electronic device can store both the access point information as well as the subscription information in this local storage for subsequent use. For example, if the electronic device is moved outside the network access point and then back into its range again, the electronic device will automatically re-establish the third communication link and re-authenticate itself with the subscription serve.

This approach may be useful for certain portable devices, like camcorders, movie cameras, digital cameras, sound recorders and the like, in which a user is recording sound or movie/pictures in a remote location and then returns to the network access point. The recorded material can then be automatically uploaded by the electronic device to the subscription service without any further user interaction. The method in accordance with the proposed principle, will simplify communication between the subscription service and the electronic device utilising the user's information stored in his or her local mobile, tablet or other UE. Apart from information about the subscription service, the UE only requires an already established connection to a network access point. Each information is shared to the electronic device.

In some instances, the first communication protocol comprises a communication standard according to one of the IEEE-802.11-Family, in particularly one of 802.11b, 802.11ac, 802.11g, 802.11ax and combinations thereof. The second communication is different from one of the standards above and comprises a shorter-range wireless standard. Exemplary non limiting embodiments for such standard are members of the Bluetooth standard, in particular Bluetooth 5.x or higher. Alternative standards are ZigBee, WiFi Direct, 6LoWPAN, Z-Wave, BLE and others.

The step of establishing by the UE a second communication link comprises in some instances the step of identifying one or more electronic device via the second communication link configured to be communicated with. Depending on the actual protocol used, those devices being ready to be paired with will identify themselves sporadically or on request by the UE. The UE may transmit a broadcast request to available electronic devices to identify themselves. This is usually part of a procedure of pairing with an electronic device. The UE may then provide a list of one or more electronic device configured to be communicated with to a user, enabling the user to select one of the one or more devices on said list. Such approach is particularly useful, if more of such devices are available, but the user only requires or wants to share the subscription information with one device.

In response to a selection by a user of one of the one or more electronic devices, the second communication link is established to said selected electronic device.

In some this regard, the subscription service may prevent sharing information with more than one electronic device. In such case, the UE may, prior to provide a list or even initiate the process of providing network or subscription information inform the user about an existing pairing between the subscription service and an electronic device and request the user to release such pairing before continuing. In an alternative embodiment, any existing pairing between a subscription and an electronic device may be released, once a new electronic device request authentication or validly authenticate itself with the subscription service.

In some other aspect, the step of providing network access information to the electronic device by the UE via the second communication link, comprises the step of identifying one or more network access point coupled to the network node using the first wireless network protocol. This step is performed by the UE in general or on request by the user. A list of one or more identified network access points is then provided to a user for selecting one of the one or more identified network access points. Those network access points can be WLAN access points for examples. In response to a selecting by a user one of the one or more identified network access points, network access information is retrieved. Those network access information are then provided to the electronic device using the second communication link.

The approach to let the user select network access information allows to choose between different access points and even an access point that is currently not used by the UE, but otherwise available. In some instances, the UE provides the access information of the first communication link, i.e. the link it is currently using to communicate with the access point.

In some further instances, the step of retrieving network access information comprise the step of providing to a user an editable field for entering authentication information to said one or more network access points. This provides an additional security field, particularly when the user selects a network access that has not been used before by the UE or to which the user has not previously authenticated the UE. Alternatively, the user may also be advised by the UE to enter network access information, that is network name and password if needed.

In response to a user's entry of authentication information, the selected network as well as the entered authentication information for the selected network access point is provided by the UE to the electronic device via the second communication link. The electronic device may store any information for accessing a WLAN network information in a non-volatile memory for subsequent use to avoid re-transmission of this information by the UE.

In some other instances retrieving network access information comprises the step of evaluating by the UE whether authentication information for the selected network access point is stored in a storage of the UE. In response to the evaluation that authentication information for the selected network access point is stored in the UE, the stored authentication information is obtained, and a network identifier is subsequently provided via the second communication link to the electronic device. Further, the obtained authentication information of the selected network access point associated with the network identifier are provided by the UE to the electronic device via the second communication link.

In case, the previous evaluate results in that no authentication information for the selected network access point is stored in the UE, the UE may provide to a user an editable field for entering authentication information to said one or more network access points and/or to at least the selected network associated with the network access point. In response to a user entry of such authentication information, the network identifier, that is an identification of the selected network access point is provided by the UE to the electronic device via the second communication link. Further, the authentication information obtained from the user are provided by the UE to the electronic device via the second communication link. Consequently, a user has full control about selecting the appropriate access point for the electronic device to establishing the third communication link. Such flexibility is suitable in some environment, in which public and private access points are available.

In some other instances, the electronic device may provide feedback to the UE via the second communication link and in particular status information on the third communication link. For example, the electronic device may provide information to the UE using the second wireless communication protocol and the second communication ling about a particular a successful authentication to the network access point and/or to a successful authentication to the subscription service.

In some instances, the electronic device comprises a display. The electronic device may be configured to provide status information regarding a successful authentication to the network access point and/or to a successful authentication or login into the subscription service on said display. Such information may be useful, when the electronic device is removed from the reach of the network access and subsequently returned thereto. Consequently, the electronic device may provide information about re-authentication to the network access point and authentication or login into the subscription service. Those features are independent of a UE.

In some instances, the electronic device may transmit data or upload files stored in its local memory to the subscription service via third communication link. The transfer of files to the subscription service can be initiated upon authentication or login into the service, but also be triggered and initiated by a user, e.g. by pushing a button or selecting the corresponding function on the display of the electronic device. In some instances, the user may initiate the upload of files by activating a respective function on the UE. The UE may transmit a corresponding command to the electronic device via the second communication link for initiating the transfer.

In some instances, and in response to completion of the transmission of data files, the electronic device may provide information about the transmission status. Such information can be displays on a display of the electronic device and/or provided to the UE using the second wireless communication protocol and the second communication link. Furthermore, the ongoing transmission of data to the substruction service may be visualized by the electronic device and/or the UE. Hence, the user is informed about the current status of the transmission and can therefore plan the next steps, e.g. processing the files, or recording some new content. For this purpose, the electronic device may in some instances continuously or periodically update status information on a display or provide such information via the second communication link to the UE.

In some further instances, the electronic device may be paired to a different subscription service. For example, the electronic device may be used by more than one user, whereas each user has his/her own subscription. In such cases, the electronic device may be re-paired to the new subscription service and the previous one released. Consequently, in some instances, the method in accordance with the proposed principle proposed to provide by the electronic device the information about the current subscription service to the UE. Hence, subscription information, optionally upon request by the UE about the current subscription is received by the UE via the second communication link. The UE may evaluate such information and compare is with its own subscription information. When the subscription information is different, the UE may request to the electronic device to release its current subscription and re-authenticate itself at the subscription service using the subscription information provided by the UE.

In an alternative embodiment, the electronic device may receive subscription information and subsequently evaluate whether the received subscription information match previous subscription information that was used by the electronic device to authenticate itself at the subscription node. Upon evaluating that the received subscription information does not match with previous subscription information, the electronic device may continue with the authentication and authenticate itself with the subscription service using the newly obtained subscription information.

However, upon evaluating that the received subscription information do match with previous subscription information, the electronic device may execute at least one of several different functions. Those functions include to provide information to a user that the electronic device was authenticated previously with the previous subscription information. Another function includes to reset the electronic device to factory settings, thereby erasing previous stored subscription information. This may be done particularly upon a user's request. The device may also continue with authenticating using the newly received subscription information.

In some instances, the electronic device may include a—in particular—protected and encrypted storage, in which subscription information can be stored. The device may also store information about the UE, e.g. a unique identifier thereof. Hence, the electronic device may have knowledge about the subscription information associated with a certain UE. In some instances, it is possible that the electronic device can establish the third communication link and login itself with the subscription information stored in the memory and associated the UE sending a corresponding request via the second communication link.

In some instances, the method in accordance with the proposed principle comprises the step of Evaluating by the electronic device whether the second communication link was previously established with said UE, when a second communication link to the electronic device shall be established by the UE. In response to evaluating that the second communication link was established with said UE, the process continues by pairing the electronic device and the UE. However, if the evaluation results in that the second communication link was previously established with another UE, the electronic device may submit status information to a user indicating that the electronic device was paired with the other UE. This can be done on the electronic device itself, i.e. showing such information on a display or provided to the UE.

Another aspect concerns a UE, said UE comprising an application in a memory of the UE, and said application being executed on said UE. The application stores subscription information for authentication to a subscription service executed on a network node of a communication network.

In accordance with the proposed principle, the UE is configured for establishing a first communication link to a network access point via a first wireless communication protocol (WLAN). The network access point is coupled to the network node. This particular step can be performed independent from the application being executed on said UE and may be a functionality in the operating system of the UE. The UE is further configured for detecting an electronic device using a second wireless communication protocol having a smaller bandwidth and a shorter range than the first wireless communication protocol.

The detection may be performed using a broadcast message provides by the second wireless communication protocol and waiting for a response. In response to detecting the electronic device, the UE establishes a second communication link to the electronic device via the second wireless communication protocol. In this regard, the second wireless communication protocol comprises a smaller bandwidth and a shorter range than the first wireless communication protocol.

After the second wireless communication protocol has been successfully established, the UE provides to the electronic device via the second communication link network access information for the first wireless communication protocol and a third communication link to the network access point. Furthermore, the UE may provide via the second communication link the subscription information to the electronic device.

In this regard, the expression “the UE may provide” shall be understood, but not limited to that the processor on the UE or the application being executed on the processor of the UE shall retrieve the necessary information from a memory of the UE and then trigger transmission of said information to the electronic device. One skilled in the art will understand that the respective functionality is usually provided by the operating system and/or the application. Consequently, in accordance with the proposed principle, the UE will establish a connection to an electronic device via a second communication protocol, providing network access information for the first wireless communication protocol as well as the necessary subscription information. Said information can be used by the electronic device to establish network access for a third communication link as well as access to the subscription service.

In some instances, the first wireless communication protocol is a high data rate protocol like 5G or 6G as well as WLAN, that is one of the IEEE-802.11-Family, in particularly one of 802.11b, 802.11g, 802.11ac, 802.11ax but is not limited thereto. The second wireless communication protocol is a lower data rate protocol that also has a shorter distance for communication than the first wireless communication protocols. Examples for a second network communication protocol includes, but is not limited to Bluetooth, NFC, ZigBee and the like.

In some aspects, the UE is configured-when establishing the second communication link-, to identify one or more electronic device via the second communication link configured to be communicated with. These electronic devices can be of different kind. The UE will provide a list of the one or more electronic device configured to be communicated with for selecting one of the one or more devices. The list can be shown to a user of the UE, whereas the user can now select one of the identified devices. The identified devices are listed with a unique identifier, supporting a user to select the desired one and not accidentally a wrong device for which the second communication link is to be established.

In response to a selection of one of the one or more electronic devices by a user, the UE will trigger the establishment of the second communication link to said selected electronic device. In this regard, the application being executed on the UE may contain some functionality to authenticate the electronic device, e.g. by a unique identifier or some key sharing functionality, to prevent phishing attempts by unauthorized devices.

In some further aspects, the aspects for providing to the electronic device via the second communication link, network access information, the UE may be further configured to identify one or more network access point coupled to the network node using the first wireless network protocol. Those network access points are intended to be used for the third communication link, that is the communication link between the electronic device and the access point. The UE may compile a list of such identified access points to be displayed to a used for selecting one of the one or more identified network access points. For example, the access points may include WLAN access points that are connected to the internet.

In response to selecting one of the one or more identified network access points by a user, the UE may retrieve the network access information associated with the selection. The network access information may include, but is not limited to unique network identifier, encryption protocol (e.g. WPA, WPA2 and the like), password for authenticating to the network and others. The information is provided to the electronic device using the second communication link.

Some further aspects concern an electronic device configured to establish a communication link using a first wireless communication protocol and a second communication link using a second wireless communication protocol. The second wireless communication protocol comprises a smaller bandwidth and a shorter range than the first wireless communication protocol. For example, the first wireless communication protocol is a high data rate protocol like 5G or 6G as well as WLAN, that is one of the IEEE-802.11-Family, in particularly one of 802.11b, 802.11g, 802.11ac, 802.11ax but is not limited thereto. The second wireless communication protocol is a lower data rate protocol that also has a shorter distance for communication than the first wireless communication protocols. Examples for a second network communication protocol includes, but is not limited to Bluetooth, NFC, ZigBee and the like.

The electronic device is configured to receive a request by a UE for establishing the second communication link using the second wireless communication protocol. In response to receiving the request, the electronic device will initiate a procedure and establish the second communication link with the UE. This procedure follows the standards set forth by the second wireless communication protocol. After the second communication link has been established, the access information for first wireless communication protocol and a third communication link to a network access point is received by the electronic device from the UE.

Furthermore, the electronic device may also receive subscription information for authentication to a subscription service configured to receive and process data files in particularly recorded sound data from said electronic device. The subscription service is executed on a network node.

The electronic device will also establish the communication link via the first communication protocol using the access information. Once the communication link via the first communication protocol has been established, the electronic device will request authentication for the subscription service at the network node using the subscription information. Once the connection to the network node and the subscription service has been established and the electronic device has successfully authenticated itself with the subscription service, the electronic device can start transmitting files to the subscription service and the network node via the communication link.

In some aspects, the electronic device is further configured to provide status information regarding the establishment of the communication link and the authentication to the subscription service. Furthermore, the electronic device can provide status information regarding the transmission of data files. This can be done during transmission or after completion of the transmission.

Some aspects concern the processing and handling of subscription information for authentication received by the UE. In some aspects, the electronic device is configured to evaluate whether the received subscription information by the UE match a previously received subscription information that was used to authenticate itself at the subscription node. Said previously received subscription information can for example be stored in a memory of the electronic device. Upon evaluating that the received subscription information does not match with previous subscription information, the electronic device may continue with a request for authentication. Hence, this is the case for an initial authentication, i.e. the electronic device has not yet been registered with the subscription service.

However, it is possible in some instances, that a plurality of user, with different subscription services may shale the same electronic device. In such a case, the electronic device, may re-register itself with the new subscription service upon request by a user.

Consequently, in some aspect, upon evaluating that the received subscription information match with do previous subscription information, the electronic device may present or provide information to a user that the electronic device was authenticated previously with some previous subscription information. For example, the electronic device may display such information on its own display or transmit such information back to the UE for display to the user. In response thereto the user may decide to continue or stop the process.

Upon continuing the authentication process with the subscription service, the electronic device may reset itself to factory settings. The electronic device may in particular delete all previous files not associated with the new subscription. Consequently, the electronic device is set to initial settings with a completely erased memory and storage. In addition, the electronic device may de-register itself with the subscription it was previously associated with. After the reset, the electronic device can continue with the authentication process using the received subscription information.

In some further aspects, the electronic device may evaluate whether the second communication link was previously established with said UE upon receiving the request to establish a second communication link to the UE using the second communication protocol. In response to the result of the evaluation different approaches may be taken. In some aspects, the electronic device may—in response to evaluating that the second communication link was previously established with said UE—pair itself directly with the UE using the information already at hand. In response to evaluating that the second communication link was previously established with another UE, the electronic device may provide status information to a user indicating that the electronic device was paired with the other UE.

The electronic device may then continue with the pairing process.

### SHORT DESCRIPTION OF THE DRAWINGS

Further aspects and embodiments in accordance with the proposed principle will become apparent in relation to the various embodiments and examples described in detail in connection with the accompanying drawings in which

FIG. 1 shows a possible setup of UE, network node and electronic device illustrating some aspects in accordance with the proposed principle;

FIGS. 2A to 2E illustrate some screen shots of a UE display for an exemplary embodiment of a method for authenticating an electronic device with a subscription service in accordance with some aspects of the proposed principle;

FIG. 3 shows a second exemplary embodiment of a method for authenticating an electronic device with a subscription service executed on a network node by use of a UE in accordance with some aspects of the proposed principle;

FIG. 4 shows a third exemplary embodiment of a method for authenticating an electronic device with a subscription service executed on a network node by use of a UE in accordance with some aspects of the proposed principle;

FIG. 5 shows a fourth exemplary embodiment of a method for authenticating an electronic device with a subscription service executed on a network node by use of a UE in accordance with some aspects of the proposed principle;

FIGS. 6A and 6B illustrate some screen shots of an electronic device display and a UE display for an exemplary embodiment of a method for authenticating an electronic device with a subscription service in accordance with some aspects of the proposed principle;

FIG. 7 illustrates some screen shots of an electronic device display and a UE display for an exemplary embodiment of a method for authenticating an electronic device with a subscription service in accordance with some aspects of the proposed principle;

FIG. 8 shows another embodiment of some steps of a method for authenticating an electronic device with a subscription service and the corresponding pairing thereto.

### DETAILED DESCRIPTION

The following embodiments and examples disclose various aspects and their combinations according to the proposed principle. The embodiments and examples are not always to scale. Likewise, different elements can be displayed enlarged or reduced in size to emphasize individual aspects. It goes without saying that the individual aspects of the embodiments and examples shown in the figures can be combined with each other without further ado, without this contradicting the principle according to the invention. Some aspects show a regular structure or form. It should be noted that in practice slight differences and deviations from the ideal form occur may without, however, contradicting the inventive idea.

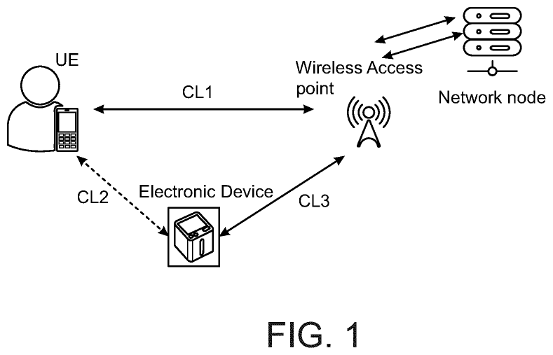

FIG. 1 illustrates a possible setup for a method of authenticating an electronic device with a subscription service executed on a network node.

The setup contains a user equipment UE, for example a mobile phone. The UE is a handheld device configured to be operated by the user. The UE comprises a memory, a storage, a processor and various applications being executed thereupon including but not limited to the operating system. The operating system as well as any application provide certain functionalities to the user, including transmission and reception of data, display information to the user request input from the user and the like.

For those purposes, the UE comprises an input device, in which a user can input characters and numbers as well as record speech pictures or movies to facilitate the operation of the user equipment and the applications being executed thereupon. In addition, the UE comprises a transceiver device that is controlled by the operating system thereof. The transceiver is configured to transmitting and receiving data via a wireless interface.

More particularly, the transceiver of the UE is configured for communicating with other transceivers using one or more different wireless communication protocols. These protocols include 3G, 4G, LTE, 5G, all of which are used in telecommunication services transmission of speech as well as data through a wireless interface to a base station. In addition, the transceiver is configured to provide other wireless communication protocols like the WLAN family suite according to the 802.11 standard. The 802.11 standard is usually used to communicate with the wireless access point to transceive data from and to the Internet.

For illustrative purposes in the present application, the WLAN protocol suite is defined herein as the first wireless communication protocol having a so-called high data rate and long-range distance. Specifically, the distance for transceiving that is transmitting and receiving data through the WLAN interface is in the range between 30 m and approximately 50 m indoor without additional repeater. The data rate is dependent on the distance, as well as potential transmission errors due to the distance, but is usually in the range of several 10 Mbits/s to several 100 Mbits/s.

In contrast thereto, the second wireless communication protocol for which the transceiver of the user equipment is configured to, comprises a lower data rate as well as a shorter distance compared to the first communication protocol. For example, the second wireless communication protocol is the Bluetooth standard class to class III standard which have a maximum distance of approximately 10 to 20 m. The data rate is usually smaller but can with the newest Bluetooth the protocols of 5.0 range of several tens of megabits per second. However, due to the increased energy consumption. One may usually use the Bluetooth low energy protocol.

The present setup also contains a Wireless Access Point or WAP, which is coupled to a network node via its Internet connection. In the present embodiment, the UE is connected to the WAP and to the Internet and the network node using the communication link CL1 facilitating the WLAN protocol.

A subscription service, not illustrated in FIG. 1 is executed on the network node. The subscription service provides individual access to user, which authenticate themselves by providing login and password information. The service subscription may require two-factor authentication, for which the user will be provided with an invitation to provide further information once he has identified and authenticated himself when accessing the subscription service. This aspect may be useful for the method proposed herein.

Typical subscription services include but are not limited to video or sound processing applications, enabling a user to upload their respective a video or sound files and subsequently edit those files within application provided by the subscription service.

The application and the subscription service are usually executed within a cloud comprising one or more processors, memory and storage. The cloud service may be distributed across several network nodes. Likewise, the subscription service and/or the application may also be distributed across several hardware components. Even further, the subscription service may be located in several countries, different from the one, the user or subscriber are currently located in. Still for simplicity purposes and the purpose of the present application the expression “network node” and “subscription service” is understood to encompass all the different implementations.

The setup further contains an electronic device. In the exemplary embodiment, the electronic device comprises one or more processors, a display with an input device, an operating system and one or more applications. The electronic device is configured to record sound or video files either directly using built in microphone and/or cameras or via external microphones and/or cameras associated and linked to the electronic device, the electronic device comprises a transceiver for transmitting the recorded files via a communication link CL3 to the WAP and to the subscription service executed on the network node.

For this purpose, the communication link CL3 utilizes a high data rate and high distance protocol similar to the communication link CL1 between the UE and the WAP. In other words, the WAP facilitates the first communication link CL1 To the UE and the third communication link CL3 to the electronic device.

In addition, the electronic device communicates with the UE via a second communication link Cl2 using the second wireless communication protocol. As stated above, the second wireless communication protocol comprises a lower data rate and a reduced distance for communication compared to the first wireless communication protocol used for the communication links CL1 and CL3, respectively.

For setting up the different communication links between the UE and the electronic device as well as between the electronic device and the WAP, and subsequently between the electronic device and the subscription service on the network node, the user will first establish the communication link CL2 between the user device UE and the electronic device.

Several different approaches are possible and will be presented herein with regards to the further figures. Generally, the UE may transmit a broadcast request as implemented in the Bluetooth protocol, to which the electronic device can respond identifying itself to the UE. An application can evaluate the response to confirm that the electronic device is a suitable device for the subscription service.

Upon selection by the user, or automatically, the electronic device is paired with the user device UE establishing the second communication link CL2. This established communication link is then used to transmit various information from and to the electronic device. For example, link CL2 can exchange subscription information for the subscription service, information for establishing communication link CL3, status information about the internal status of the electronic device, about the upload progress and the like.

More particular, some information may include identifier and password for the WAP, which is also used by the UE for the first communication link CL1. In addition, the user equipment may also provide subscription information to the electronic device to establish a communication with the subscription service on the network node once of the communication link CL3 has been set up successfully.

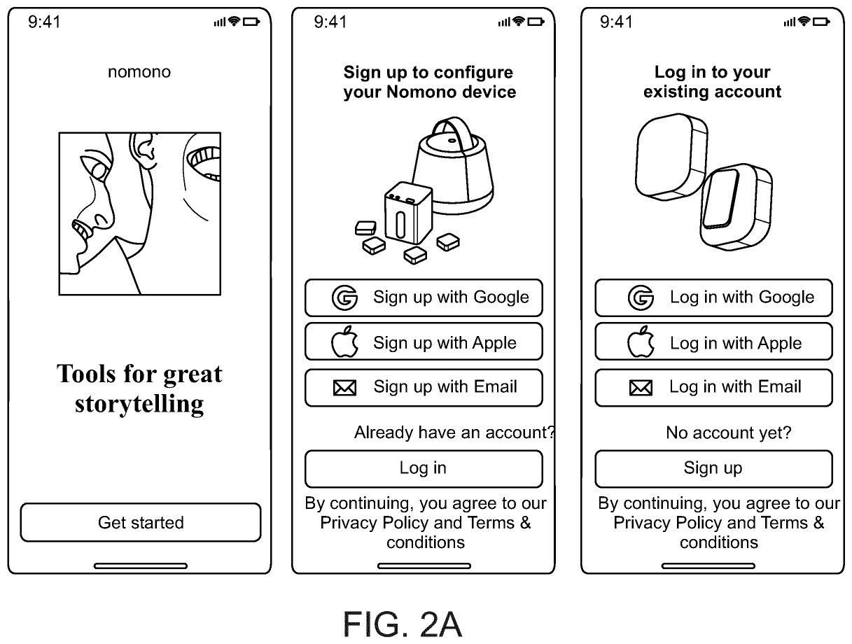

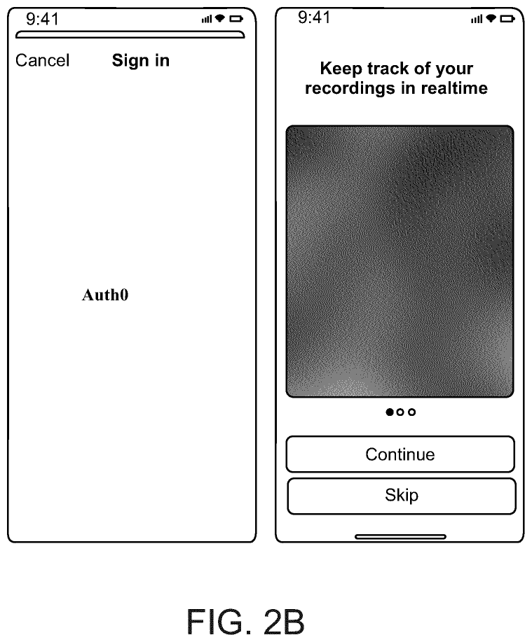

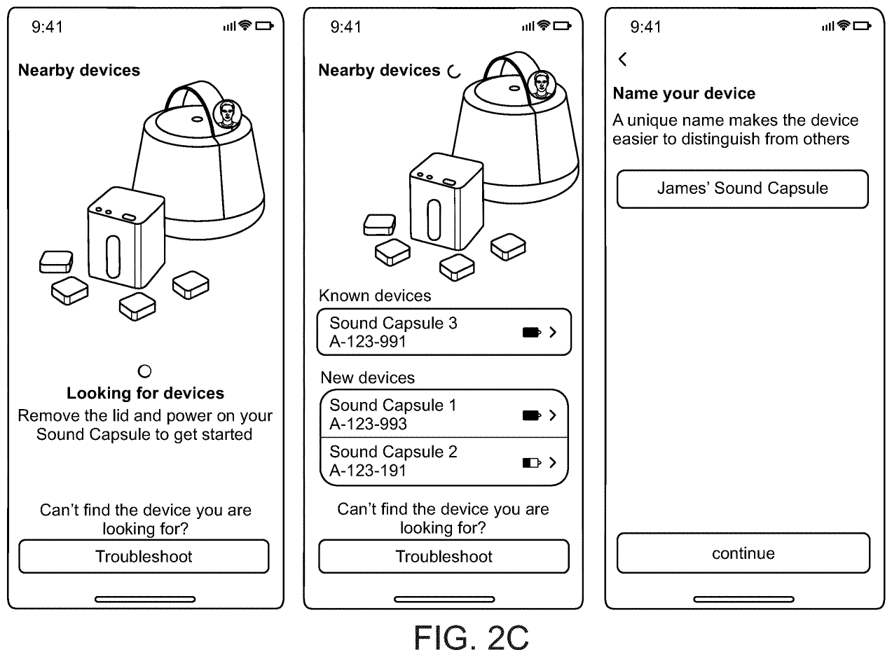

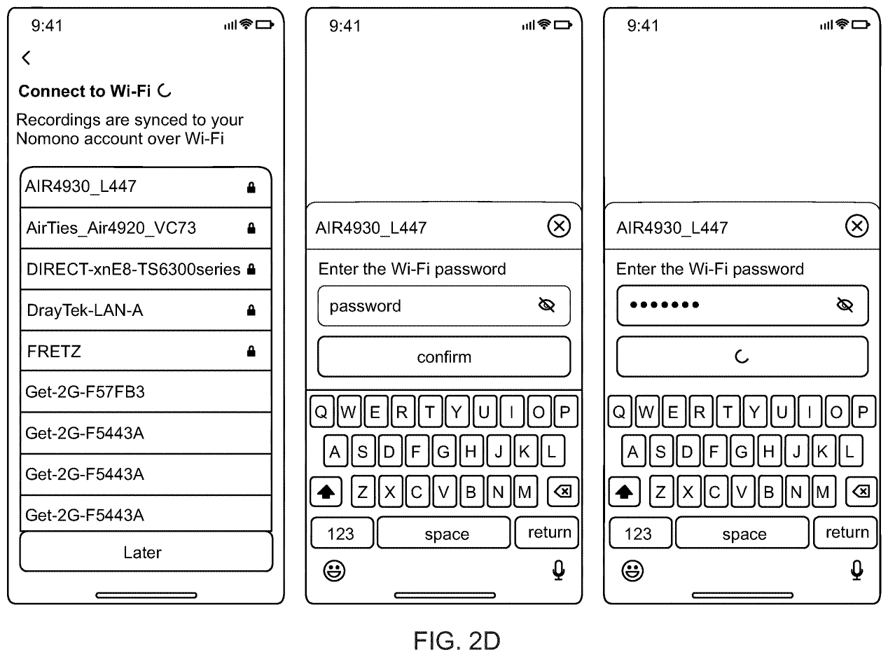

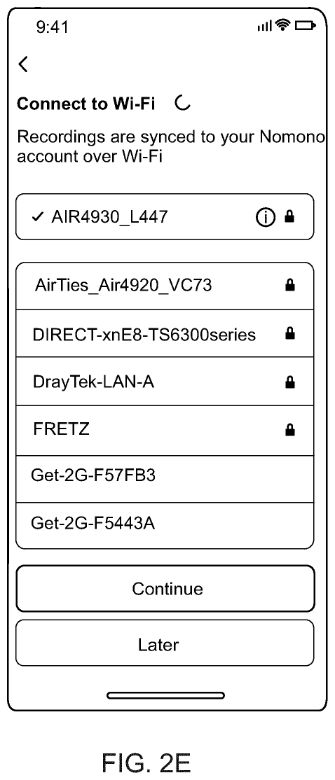

FIGS. 2A to 2D illustrate various screens on the display of the UE, on which an application for setting up the communication between the mobile and the electronic device and subsequently between the electronic device and the subscription service is executed.

The various screens provide the user with status information about the set-up process, in accordance with the proposed principle but also invites the user to change or adjust certain settings in correspondence with the needs and desire.

FIG. 2A illustrates the start screen which subsequently invites the user to sign up to the subscription service either using his/her respective accounts by Google® or Apple® or as a further alternative an email address. In this regard, the middle screen is illustrated if the user signs up for the first time to the subscription service. If the user has already used the application and associated his/her UE with the subscription service, the right screen may be displayed. A two-factor authentication as illustrated in FIG. 2B may be used herein to ensure that rightful owner of the subscription service utilizes the service. In some instance an automatic log-on procedure is possible to simplify the process. Subscription information as well as password (if any) is stored in the UE in an encrypted form.

After logging in with the application to the subscription service and successful authentication with that service, the application utilizes the operating system of the mobile to initiate a broadcast message via the Bluetooth protocol looking for available Bluetooth devices. The electronic device being activated utilizes the same Bluetooth protocol, listens to such broadcast messages and can respond thereto. FIG. 2C shows a left screen providing status information indicating to the user that the application on the UE is looking for available devices. In this regard, the application also invites the user during the set-up process for the second communication link prepare the device, and particularly turn it on in case the user hasn't done so.

In a subsequent following step, illustrated in the second screen of FIG. 2C, an application list is shown on the display with all Bluetooth devices being available. The device list is split into a sub list with learned known devices (previously paired) in the present case identified as Sound Capsule 3, as well as new devices identified as Sound Capsule 1 and 2, respectively.

In this regard it is noted that the application provides a list of devices, which have identified themselves as compatible devices to the subscription service. The compatibility can be for example included in the identifier of the electronic device itself, for instance by its unique identifier. The sub-list in FIG. 2C with the split enables a user either continue known to with an already device, thereby significantly increasing the speed of the subsequent authentication process, but also to establish a communication link to a new device enabling that new device to authenticate itself subsequently with the network node at the subscription service, respectively.

Upon response and input by the user selecting one of the displayed devices, the second communication link CL2 via Bluetooth protocol is established. The user may also for example change the name of the device to provide an individual name which makes a device easier to distinguish from other devices.

In a subsequent step illustrated in FIG. 2D, the user is then displayed with a list of wireless access points, WAPs available via the WLAN protocol. WLAN is selected as it usually provides a higher bandwidth than the Bluetooth protocol used for establishing the communication between the UE and the electronic device. The list of available WAPs nodes can be taken from the functionality of the operating system, which also provides functionality displaying the available WAPs for selection. The list contains all visible WAPs, also indicating an encrypted communication link. Upon a selection of one of the available WAPs, the user is invited to enter the WLAN password for the respective WAPs indicated in the middle screen. After inserting the WLAN password, the password is checked.

If a connection can be established, shown in FIG. 2E, the information is subsequently provided together with the unique identifier of the WAP to the electronic device over the second communication link CL2. If the WAP is already known to the UE, that is the authentication information is known, the step of adding the password can be omitted and—upon selection of the WAP by the user—the information is directly transmitted to the electronic device.

In a subsequent step, the electronic device establishes the third communication link CL3 to the WAP using the information provided by the UE. In response thereto, and after successfully establishing the third communication link, the electronic device provides the respective network status information back to the UE for display to the user, see FIG. 2E. This will indicate to the user that the electronic device has successfully established communication link CL3.

In addition, the electronic device now tries to establish communication to the network node and the subscription service being executed thereupon and will authenticate itself with the respective subscription information provided by the application executed on the UE. Such information is transmitted from the UE to the electronic device via the second communication link CL2.

Upon a successful connection and authentication to the subscription service, the electronic device starts uploading recently recorded soundtracks to the subscription service but also indicate the status of such process to the user via the Bluetooth communication link CL2. The status information is illustrated in FIG. 2E, indicating that the electronic device is connected to the WAP and the recordings by the electronic device are now synced to the account over the WLAN interface.

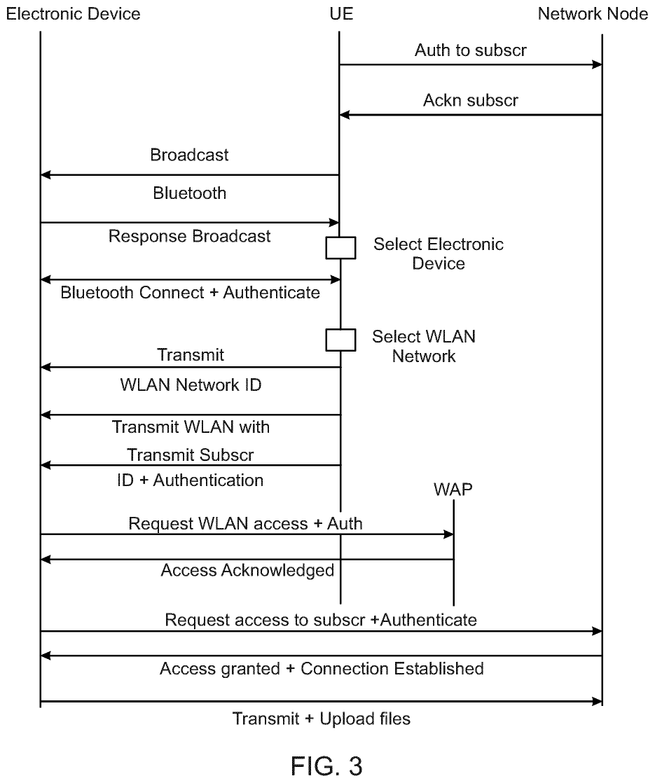

FIG. 3 illustrates several aspects of a method for authenticating an electronic device with a subscription service being executed on a network node. The figure illustrates three swim lanes indicated as Electronic Device, UE and Network Node, respectively. A fourth swim lane referred to as WAP is also shown herein.

In an initial step, the UE will initiate and authenticate itself with the subscription service being executed on the network node using the first high data communication link CL1 between the UE and the WAP connected to the network node. If the authentication to the subscription service is successful, that is, login and password match an already existing subscription, an acknowledgment is provided by the network node to the UE. Consequently, the application executed on the UE is now associated with an active subscription on the subscription service at the network node.

In a subsequent step, a broadcast message using the Bluetooth protocol is cast into the surroundings of the UE and received by the electronic device listening to broadcast calls. The electronic device responds thereto. After some time, the available devices are displayed by the UE to the user, whereas the user can select the electronic device responding to the broadcast. In a subsequent step, a Bluetooth connection between the electronic device and the UE is established forming the second communication link CL2. The second communication link CL2 can provide information into the application executed on the UE. In a subsequent step, the user can now select an available WLAN network and wireless Access point associated therewith.

For this purpose, the available WLAN networks are displayed to the user, wherein the user can either select a WLAN network, for which the UE is already connected to, and the password is known, or he can, upon selection of a respective WLAN network and WAP enter the corresponding password himself. In either case, the information associated with the selected WLAN network and WAP, including the unique identifier as well as the password (in case of an encrypted network is selected) is transmitted via the Bluetooth communication link to the electronic device.

In some aspects, the UE may first transmit the unique identifier of the selected network. This may be sufficient if the electronic device was previously connected to said network and has not yet automatically restored the connection. In addition to the network identifier and the associated password, the application executed on the UE will also transmit the respective unique identifier and the authentication for the subscription service on the network node. The information transmitted correspond to the data which the application used for its own previous authentication the subscription service.

After the reception of both information, the electronic device can now request a WLAN access and provides the respective authentication and password to the WAP being connected to the network node. The access is granted and the third communication link CL3 established. After successful setup of the third communication link, the electronic device now requests access to the subscription service being executed on the network node. The subscription service may respond with a handshake and require proper authentication. The electronic device now utilizes the previously transmitted ID and authentication for the subscription service to request access.

The access is granted upon a successful authentication, and a connection to the subscription service established. The electronic device can start transmitting and uploading files to the subscription service on the network node.

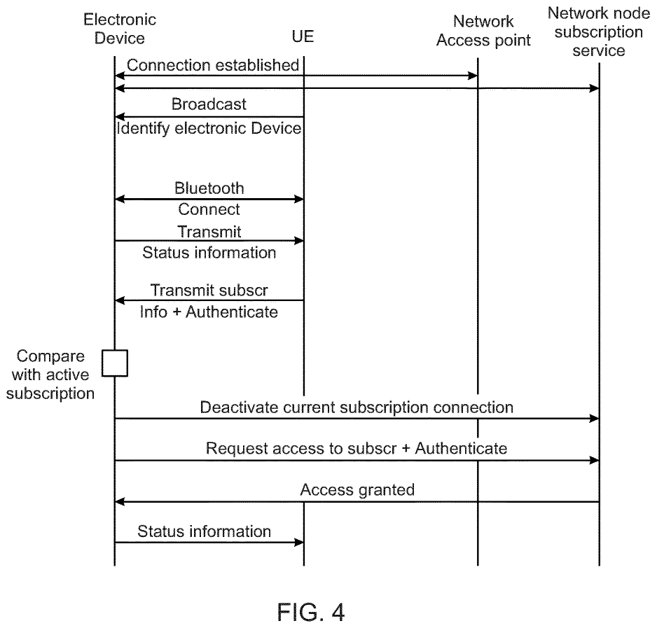

FIG. 4 illustrates a further embodiment of a method for authenticating an electronic device with the subscription service being executed on a network node. FIG. 4 shows four swim lanes indicated as Electronic Device, user equipment UE, Network Access point, referred to as WAP and the network noted with the subscription service executed upon. In this embodiment an existing connection is established from the electronic device to the WAP as well as to the network node and the subscription service executed thereupon. Hence the electronic device is connected to and has already authenticated itself with the subscription service. This can be for example a subscription associated with user 1.

The electronic device will receive a broadcast message from a UE belonging to user 2 to identify itself using the Bluetooth protocol. User 2 also has a valid subscription with the subscription service. In response to the broadcast message, the electronic device will establish a Bluetooth connection and transmit status information. The UE transmit the subscription information and authentication to the service to the electronic device.

The electronic device will compare the transmitted subscription information and the authentication information with the already active subscription. If the subscription information and authentication is the same indicating that the user with the same subscription to the subscription service is requesting communication with the electronic device, the electronic device can continue normally.

In response that the comparison between the transmitted subscription information and the already active subscription is different (i.e. subscription of user 1 is different from the subscription of user 2), the current subscription connection is deactivated. For this purpose, the electronic devices will send log out request to the subscription service indicating to the service that the electronic device will deactivate its connection.

In a subsequent step, the electronic device will request access to the subscription service using the previously transmitted subscription information and authentication information from the UE. In response to a successful authentication and after access is granted to the electronic device, the electronic device updates the status information via the Bluetooth channel to the UE. In a subsequent step not illustrated in FIG. 4, the electronic device may now upload recorded files associated with the subscription of user 2 in tis storage to the network node.

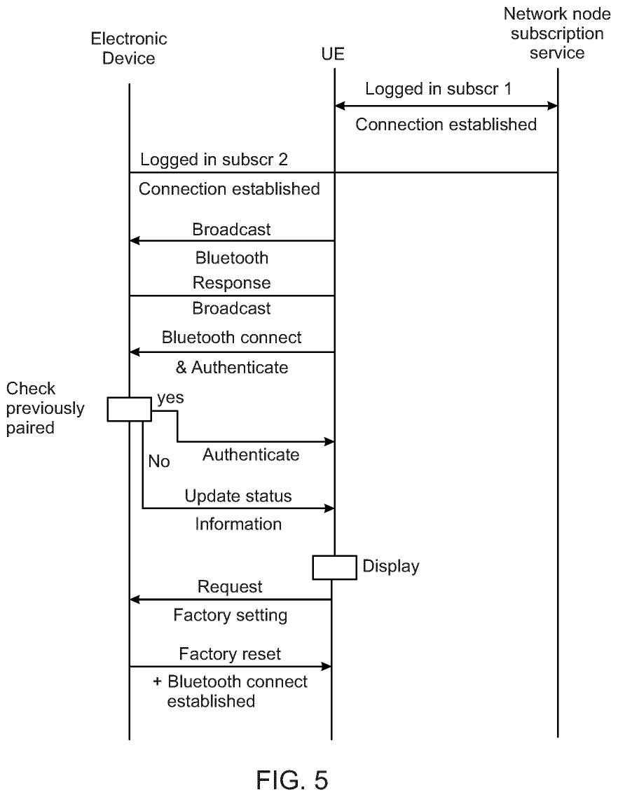

FIG. 5 shows further embodiment for authentication of an electronic device whether subscription service being executed on network node. In this embodiment, the UE is logged with a first subscription subscr 1 to the network node and the subscription service. Further, the electronic device has established a WLAN connection to a WAP (not shown herein) and a connection to the subscription service associated with subscription subscr2.

The method includes sending out a broadcast message using the Bluetooth protocol by the UE, which is subsequently received by the electronic device in accordance with the selected protocol. The electronic device will response to the broadcast message. Upon the response of the electronic device, the application on the user equipment tries to establish a Bluetooth connection and authenticates with the electronic device.

The electronic device has the possibility to evaluate whether the electronic device has previously communicated with the respective UE or not. This approach provides an additional security but can also be sued if more UE and different subscription share the same electronic device.

If the UE is known to the electronic device (i.e. they have used communication link 2 before, or the identifier of the UE is found in the electronic device's memory, the electronic device will continue and authenticate itself establishing the Bluetooth connection CL2 between the device and UE. If the UE is not found, or no connection was previously established, a status information message can be transmitted to the user equipment and illustrated by the application executed on the UE on its display. The user can now select and decide he want to continue with the pairing process or if the UE shall be disconnected.

In the former case, the application executed on the UE will request a factory reset to the electronic device for subsequent re-connection and re-authentication with the application and the corresponding first subscription service. Alternatively, the Bluetooth connection can first be established and then the UE will issue a factory reset.

The electronic device,—upon receipt of such request—will reset itself to factory settings. The factory reset includes, for example, erasing the memory and storage such that no previous recorded files are left on the electronic device. In addition, the second subscription information previously stored on the electronic device will be deleted. This functionality provides a solution in cases in which the electronic device is switched between different users or re-sold to a different user using a different subscription on the subscription service.

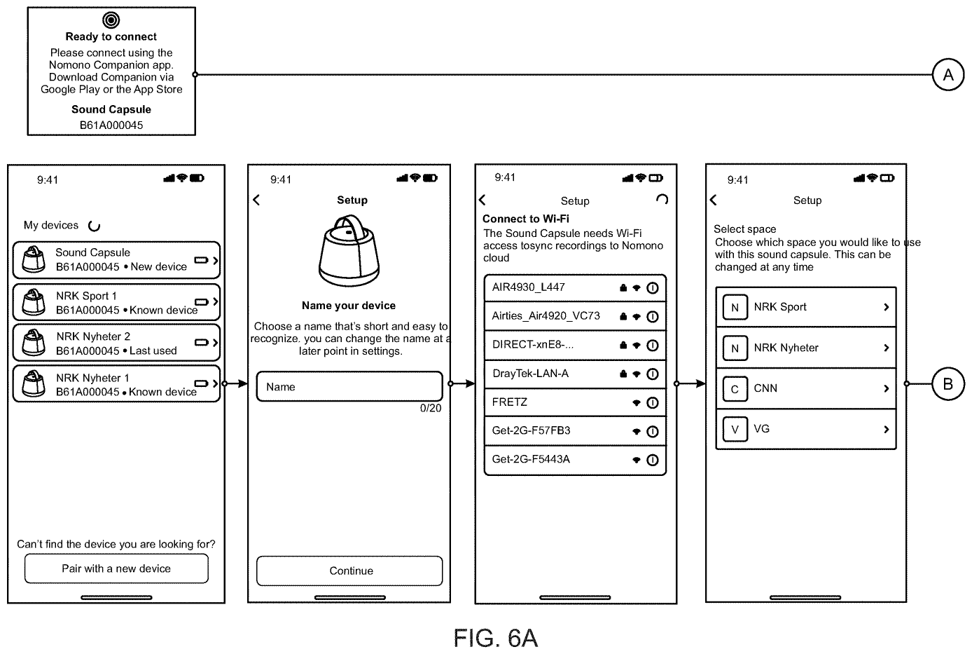

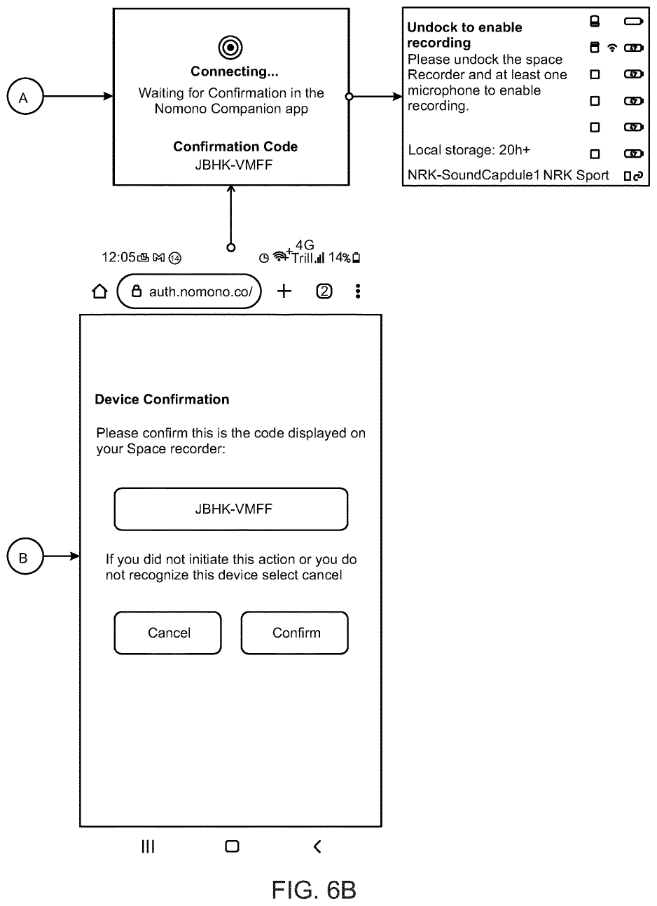

FIGS. 6A and 6B illustrates further screen shots of the user equipment and the electronic device display during a method of authenticating an electronic device with an existing subscription service. In the upper swim lane depicted with “A”, the display of the electronic device is illustrated. The lower swim lane with the screen shots of the UE display is depicted with “B”.

In the first screen on the left side, the application executed on the UE lists several existing and identified devices associated with the corresponding UE including their identifier as well as their battery level. In addition, the user has the possibility to pair the application on the UE with an additional device.

If the user selects a new device, the next screen will appear in which the user has the possibility after the Bluetooth connection to the device has been established to enter an individual name for easier and quicker recognition. In a subsequent step, the user is invited to select one or more of the available wireless access points, WAPs and provide to the corresponding authentication and password associated with the WAP. This information is sent to the electronic device already having an established communication link CL2 with the user equipment.

The next most right screen offers the user to select a certain space which can be used with the electronic device. These spaces can include a space associated with the respective subscription service to which the user equipment is connected to, but also a storage space set on the electronic device itself. Furthermore, the rightmost screen may indicate several possible subscription services to which the application being executed on the UE, the user or the electronic device was previously associated with. In such cases, the user may be invited to provide further authentication and password for the respective subscription service.

FIG. 6B illustrates the screens for the next step, which provides an additional security measure. After selecting a respective space, the electronic device contacts the subscription service using a unique identifier. The subscription service generates a pairing code and sends it back to the electronic device for display.

The user is—at the same time provides with a screen on the UE inviting him to enter the code displayed on the electronic device. Upon entering a respective code, the application provides the code back to the subscription service. Upon a matching, the pairing between the UE and the electronic device, both associated with a certain subscription is accepted. The display on the electronic device may then provide further information on its respective display indicating of for example, the amount of remaining storage time,—in this case more than 20 hours of recording space—, the status of the wearable microphones associated with the recording device as well as other information.

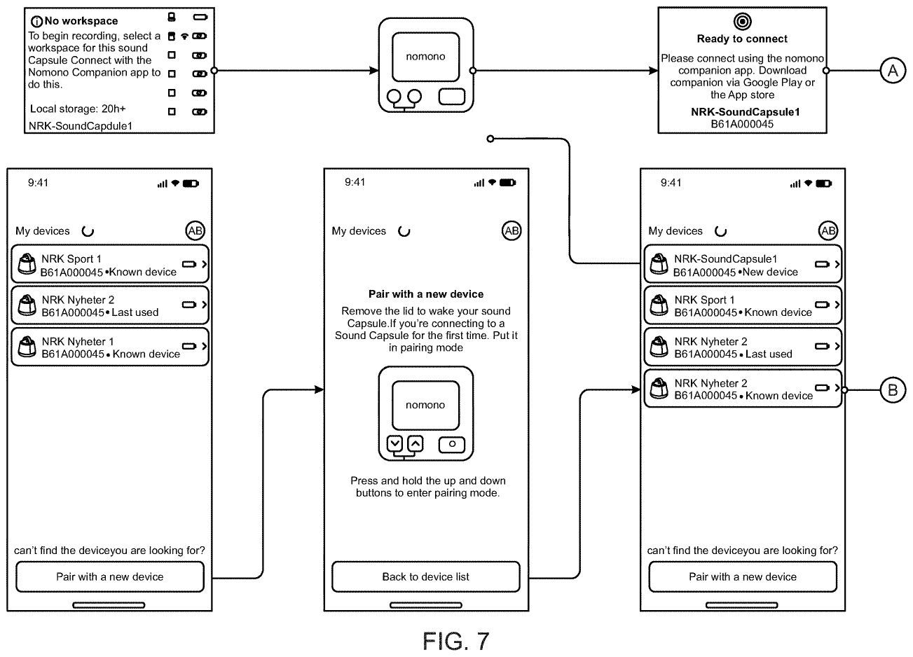

FIG. 7 illustrates some further details of for a method authenticating the electronic device with the respective user equipment and the application executed thereupon using the Bluetooth protocol. In the upper swim lane (depicted as “A”) screen shots of the electronic device's display are illustrated, while the lower swim lane “B” illustrates several screenshots of the application executed on the UE. In this particular embodiment, the user would like to pair the application with a new device, which is done by pressing the bottom button on the first leftmost screen of FIG. 7. After pressing the button, a new screen appears, inviting the user to press buttons on the input interface of the electronic device. Continuing with the pairing process, once the new device has been paired with the application and the Bluetooth link between both has been established, the new device is shown on the list of electronic devices. In addition, a respective message is illustrated on the display of the electronic device to invite the user for the next step, namely the connection of the electronic device to an available WAP.

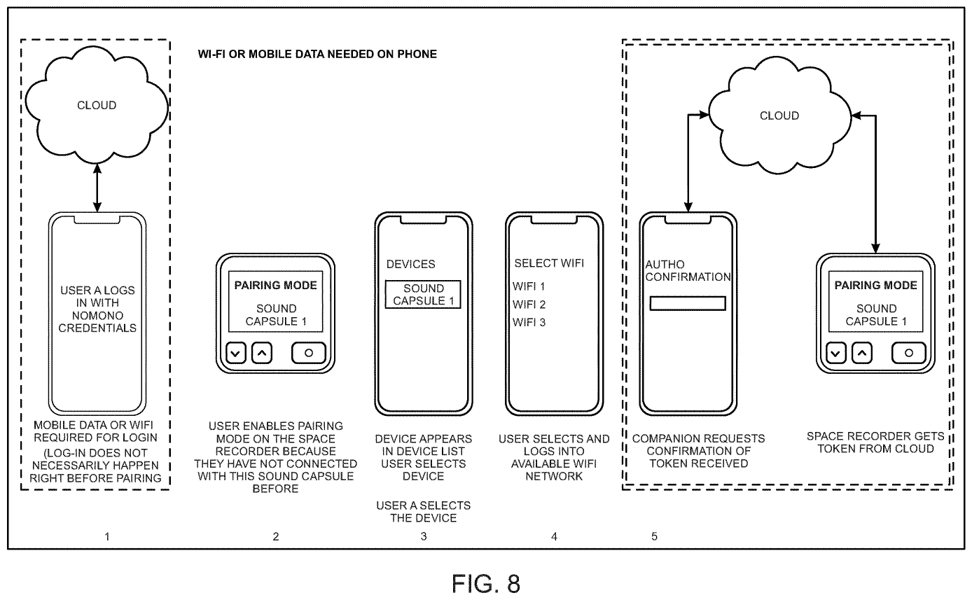

FIG. 8 illustrates a further embodiment of the authentication process and the pairing process between the application executed on the user equipment and the electronic device. The respective process includes five different steps.

The first step is similar to the previous embodiments, wherein a user a has logged onto a service with its subscription detail also referred to as credentials. In a subsequent step (depicted as step 2), the user now pushes a button on the electronic device to set the electronic device in pairing mode that requires a Bluetooth connection. The Bluetooth connection is done in a similar fashion to the previous embodiment, e.g., by a broadcast signal, which subsequently allows the user to select the respective electronic device out of a list of available devices presented on the screen of his UE.

In a subsequent fourth step, the user also selects an available WLAN network and WAP. The respective identification and authentication information to the WLAN network is provided from the UE to the electronic device.

In the last step, the UE transmits the information related to the pairing with the electronic device to the subscription service on the network node via the first communication link CL1. The subscription service contains a database with valid and active subscriptions as well as the unique identifier for the electronic devices. The information submitted to the subscription service contains the identifier of the electronic device.

In response to such request, the subscription service attempts to contact the electronic device using the third communication link. If the attempt is successful, the subscription service communicates with the electronic device via the third communication link transmitting an authentication code to be displayed by the electronic device. The user can read the code from the display of the electronic device and enter the code in the application on its UE. The entered authentication code is sent back into the subscription service, which—upon match—in turn associates the electronic device with the user and the application on the UE. The electronic device is no associated with the same subscription as the user on the UE.

The proposed method provides a high flexibility to identify and associate electronic device with an existing subscription on the subscription service being executed on a cloud using different network protocols. In particular, the communication between the UE and the electronic device occurs via a low data rate and a small distance protocol like Bluetooth and the like.

The UE will establish a respective communication link to the electronic device and further issued certain information to the device, which in turn enables the device to communicate via a higher data rate protocol to the subscription service. Various security measures can be implemented to ensure that the user equipment can only pair and associate itself with an electronic device to which the user of the equipment and the subscriber of the service has physical access to. This will also allow different subscribers to share certain devices or use a single subscription for a plurality of different electronic devices being paired with the respective user equipment.

1. A method for authenticating an electronic device with a subscription service executed on a network node by use of a UE, said subscription service configured to receive and process data files, in particularly recorded sound data, from said electronic device; wherein the UE stores subscription information for authentication to the subscription service, said subscription associated with a user or a user group; the method comprising the steps of:
establishing by the UE a first communication link to a network access point via a first wireless communication protocol (WLAN), said network access point connected to the network node by a communication network;
establishing by the UE a second communication link to the electronic device via a second wireless communication protocol having a smaller bandwidth and a shorter range than the first wireless communication protocol;
providing to the electronic device by the UE via the second communication link, network access information for the first wireless communication protocol and a third communication link to the network access point;
providing by the UE via the second communication link the subscription information to the electronic device;
establishing by the electronic device the third communication link to the network access point using the first wireless communication protocol (WLAN); and
authenticating by the electronic device via the third communication link, the electronic device to the subscription service using the subscription information.

2. The method according to claim 1, wherein the first communication protocol comprises a communication standard according to one of the IEEE-802.11-Family, in particularly one of 802.11b, 802.11g, 802.11ac, 802.11ax and combinations thereof and wherein the second communication comprises one of the Bluetooth family, in particular one of the Bluetooth 5.x or higher.

3. The method according to claim 1, wherein establishing by the UE a second communication link comprises:
identifying one or more electronic device via the second communication link configured to be communicated with;
providing a list of the one or more electronic device configured to be communicated with for selecting one of the one or more devices; and
in response to selecting by a user of one of the one or more electronic devices;
establishing the second communication link to said selected electronic device.

4. The method according to claim 1, wherein providing to the electronic device by the UE via the second communication link, network access information comprises:
identifying one or more network access point coupled to the network node using the first wireless network protocol;
providing a list of the one or more identified network access points to a user for selecting one of the one or more identified network access points;
in response to selecting by a user one of the one or more identified network access points; and
retrieving network access information and providing such information to the electronic device using the second communication link.

5. The method according to claim 4, wherein retrieving network access information comprises:
providing to a user an editable field for entering authentication information to said one or more network access points; and
in response to a user entry of authentication information:
providing via the second communication link to the electronic device identification of the selected network access point; and
providing via the second communication link to the electronic device the authentication information of the selected network access point.

6. The method according to claim 4, wherein retrieving network access information comprises:
evaluating whether authentication information for the selected network access point is stored in the UE;
in response to the evaluation that authentication information for the selected network access point is stored in the UE:
obtaining the stored authentication information;
providing via the second communication link to the electronic device identification of the selected network access point; and
providing via the second communication link to the electronic device the obtained authentication information of the selected network access point;
in response that no authentication information for the selected network access point is stored in the UE:
providing to a user an editable field for entering authentication information to said one or more network access points; and
in response to a user entry of authentication information:
providing via the second communication link to the electronic device identification of the selected network access point; and
providing via the second communication link to the electronic device the authentication information of the selected network access point.

7. The method according to claim 1, wherein authenticating by the electronic device via the third communication link comprises:
providing by the electronic device status information, in particular a successful authentication to the UE using the second wireless communication protocol.

8. The method according to claim 1, further comprising:
upon authentication transmitting via the third communication link data files to the subscription service; and
in response to completion of the transmission of data files:
providing by the electronic device transmission status information to the UE using the second wireless communication protocol.

9. The method according to claim 1, wherein Providing by the UE via the second communication link the subscription information comprises:
receiving by the electronic device the subscription information;
evaluating by the electronic device whether the received subscription information match previous subscription information that was used by the electronic device to authenticate itself at the subscription node;
upon evaluating that the received subscription information does not match with previous subscription information:
continuing with Authenticating; and
upon evaluating that the received subscription information do match with previous subscription information:
providing information to a user that the electronic device was authenticated previously with the previous subscription information; and
optionally resetting the electronic device to factory settings, in particular upon user request; and
continue with Authenticating using the received subscription information.

10. The method according to claim 1, wherein Establishing by the UE a second communication link to the electronic device via a second wireless communication protocol comprises:
evaluating by the electronic device whether the second communication link was previously established with said UE;
in response to evaluating that the second communication link was established with said UE:
pairing the electronic device and the UE;
in response to evaluating that the second communication link was previously established with another UE; and
providing status information to a user indicating that the electronic device was paired with the other UE.

11. A UE comprising an application in a memory of the UE, the application being executed on said UE, the application storing subscription information for authentication to a subscription service executed on a network node of a communication network, the UE configured to:
establishing a first communication link to a network access point via a first wireless communication protocol (WLAN), said network access point coupled to the network node;
detecting an electronic device using a second wireless communication protocol having a smaller bandwidth and a shorter range than the first wireless communication protocol; and
in response to detecting the electronic device:
establishing a second communication link to the electronic device via the second wireless communication protocol, wherein the second wireless communication protocol comprises a smaller bandwidth and a shorter range than the first wireless communication protocol;
providing to the electronic device via the second communication link network access information for the first wireless communication protocol and a third communication link to the network access point; and
providing via the second communication link the subscription information to the electronic device.

12. The UE according to claim 11, wherein for establishing the second communication link, the UE is further configured to:
identify one or more electronic device via the second communication link configured to be communicated with;
provide a list of the one or more electronic device configured to be communicated with for selecting one of the one or more devices; and
in response to selecting by a user of one of the one or more electronic devices;
establish the second communication link to said selected electronic device.

13. The UE according to claim 11, wherein for providing to the electronic device via the second communication link, network access information, the UE is further configured to:
identify one or more network access point coupled to the network node using the first wireless network protocol;
provide a list of the one or more identified network access points to a user for selecting one of the one or more identified network access points;
in response to selecting by a user one of the one or more identified network access points; and
retrieve network access information and providing such information to the electronic device using the second communication link.

14. An electronic device configured to establish a communication link using a first wireless communication protocol (WLAN) and a second communication link using a second wireless communication protocol the second wireless communication protocol comprises a smaller bandwidth and a shorter range than the first wireless communication protocol; the electronic device configured to:
receiving a request by a UE for establishing the second communication link using the second wireless communication protocol;
in response to receiving the request, establishing the second communication link with the UE;
receiving access information for first wireless communication protocol (WLAN) and the communication link to a network access point by the UE;
receiving subscription information for authentication to a subscription service executed on a network node, said service configured to receive and process data files, in particularly recorded sound data from said electronic device;
establishing the communication link via the first communication protocol using the access information;
request authentication for the subscription service at the network node using the subscription information; and
upon authentication transmitting via the communication link data files to the subscription service.

15. The electronic device according to claim 14, wherein the electronic device is further configured to:
in response to completion of the transmission of data files;
providing status information to the UE using the second wireless communication protocol.

16. The electronic device according to claim 14, wherein for receiving subscription information for authentication, the electronic device is configured to:
evaluating whether the received subscription information match previous subscription information that was used to authenticate itself at the subscription node;
upon evaluating that the received subscription information does not match with previous subscription information:
continuing with request authentication; and
upon evaluating that the received subscription information do match with previous subscription information:
providing information to a user that the electronic device was authenticated previously with the previous subscription information, or
providing status information to the UE that the electronic device was authenticated previously with the previous subscription information; and
optionally resetting the electronic device to factory settings, in particular upon user request;
continue with authenticating using the received subscription information.

17. The electronic device according to claim 14, wherein in response to receiving the request, the electronic device is further configured to:
evaluating by the electronic device whether the second communication link was previously established with said UE;
in response to evaluating that the second communication link was established with said UE:
pairing with the UE;
in response to evaluating that the second communication link was previously established with another UE; and
providing status information to a user indicating that the electronic device was paired with the other UE.

18. The method according to claim 1, wherein the first communication protocol comprises a communication standard according to one of the IEEE-802.11-Family, in particularly one of 802.11b, 802.11g, 802.11ac, 802.11ax and combinations thereof and wherein the second communication comprises one of the Bluetooth family, in particular one of the Bluetooth 5.x or higher.

19. The UE according to claim 12, wherein for providing to the electronic device via the second communication link, network access information, the UE is further configured to:
identify one or more network access point coupled to the network node using the first wireless network protocol;
provide a list of the one or more identified network access points to a user for selecting one of the one or more identified network access points;
in response to selecting by a user one of the one or more identified network access points; and
retrieve network access information and providing such information to the electronic device using the second communication link.

20. The electronic device according to claim 14, wherein the first communication protocol comprises a communication standard according to one of the IEEE-802.11-Family, in particularly one of 802.11b, 802.11g, 802.11ac, 802.11ax and combinations thereof and wherein the second communication comprises one of the Bluetooth family, in particular one of the Bluetooth 5.x or higher.
